(19) United States
(12) Patent Application Publication
(10) Pub. No.: US 2013/0337146 A1
(43) Pub. Date: Dec. 19, 2013

(54) BAKED CONFECTIONERY

(71) Applicants: Takashi Katagiri, Sakado-shi (JP); Sayuri Takezoe, Sakado-shi (JP); Noriyuki HIrota, Sakado-shi (JP); Hiroyuki Utsunomiya, Sakado-shi (JP); Saori Toriwa, Sakado-shi (JP)

(72) Inventors: Takashi Katagiri, Sakado-shi (JP); Sayuri Takezoe, Sakado-shi (JP); Noriyuki HIrota, Sakado-shi (JP); Hiroyuki Utsunomiya, Sakado-shi (JP); Saori Toriwa, Sakado-shi (JP)

(73) Assignee: Meiji Co., Ltd., Tokyo (JP)

(21) Appl. No.: 14/003,566

(22) PCT Filed: Mar. 8, 2012
(86) PCT No.: PCT/JP2012/055953

§ 371 Date: Sep. 6, 2013

(30) Foreign Application Priority Data
Mar. 8, 2011 (JP) 2011-050871

(51) Int. Cl. A23G 3/42

(52) U.S. Cl. CPC A23G 3/42
USPC 426/613; 426/660

(57) ABSTRACT

The purpose of the present invention is to provide baked fatty or oily confectionery being crispy to the core but giving no burning feel, and a method for producing the same. The baked confectionery can be produced by preparing a fatty or oily confectionery composition containing a glucide, said glucide being selected from among isomaltulose, mannitol and reduced palatinose, and then baking the composition.

### TECHNICAL FIELD

The present invention relates to baked confectionery; in particular, the present invention relates to baked fatty or oily confectionery with crispy texture to the core.

### BACKGROUND ART

Conventionally, attempts to improve textures of fatty or oily confectionery have been made.

In Patent Document 1, a manufacturing method of fatty or oily confectionery with excellent heat resistance which is characterized in that a fatty or oily confectionery composition such as a chocolate composition, etc., is solidified by heating at 80° C. or higher for a few seconds to several cozen minutes has been disclosed, and replacement of some or all of the sugar used for the fatty or oily confectionery with crystalline glucose, etc. has been proposed. However, investigation of the effect of solidification conditions on the texture is made only for the fatty or oily confectionery in which sugar alone is used as a glucide except the lactose contained in a powdered milk, and this invention is not the one that provides baked fatty or oily confectionery with crispy texture to the core, without burnt taste.

In Patent Document 2, a manufacturing method of baked confectionery using chocolate as a main raw material has been disclosed, which aims at providing a manufacturing method of baked confectionery that keeps its shape, does not become sticky, and can be eaten without making the hands dirty even when it is left at a temperature higher than the melting point, and also that has a light crunchy texture, and can keep its shape upon baking, wherein the method is characterized in that air bubbles are contained in a chocolate composition and then the composition is formed and solidified by baking; as an effect of this method, a baked taste is imparted to the chocolate, and baked confectionery with unique taste and texture, having a biscuit-like texture at least at its surface can be obtained. In addition, by means of inclusion of air bubbles, shape retention property upon baking is improved and heat can be transferred more quickly, so that a light crunchy texture after baking can be obtained.

In Patent Document 3, a manufacturing method of chocolate confectionery has been disclosed, which aims at obtaining chocolate confectionery with novel texture, having both a light and crispy light texture of baked confectionery and a texture in which crushed pieces are melting in the mouth, wherein the method is characterized in that a chocolate composition comprising a starch raw material and water is formed, which is directly baked or heated by high-frequency wave. As its effect, a novel food product having a texture completely different from a snap texture of conventional typical chocolate, i.e., a novel baked-confectionery-like light texture, can be provided.

Furthermore, in Patent Document 4, a manufacturing method of baked confectionery has been disclosed, which aims at providing baked confectionery using chocolate as a main raw material, having accumulated-snow-like external appearance in which this decoration hardly peels off, having crunchy texture at its outer part with internal different texture, as well as a manufacturing method thereof, wherein the method is characterized in that in a manufacturing method of baked confectionery comprising forming a chocolate composition and baking and solidifying the composition, the method comprises a step of spraying water onto at least part of the outer surface of the formed chocolate composition, and adhering saccharides onto the surface, then baking the composition; as a result, the obtained baked confectionery has an accumulated-snow-like external appearance and this decoration hardly peels off, and the external baked sugarcoating exhibits crispy texture that, is different from internal texture.

In Patent Document 5, a white-colored food material that is a food material to be mixed into food products subjected to a baking step, and that is not colored even after baking, has been disclosed; and a food material that is a fatty or oily composition comprising 50-70 wt % lactose has been proposed. However, there is no investigation on the texture.

In Patent Document 6, a composition for baked confectionery has been proposed, which aims at providing baked confectionery having rich chocolate taste with less powdery texture, that melts smoothly in the mouth; the composition comprises saccharides, water and a chocolate composition, but does not comprise starch raw materials; and baked confectionery using reduced starch saccharified product, high-fructose corn syrup, lactose and erythritol as a glucide has been disclosed. However, there is no investigation on the texture except the texture of smoothly melting in the mouth.

In Patent Document 1, baked confectionery obtained by baking a bakery dough that wraps a chocolate composition has been described, and baked confectionery using high-fructose corn syrup and sorbitol solution in the chocolate composition has been proposed. However, this is not the one wherein the chocolate composition itself is baked, and there is no investigation on the texture of the prepared chocolate composition itself.

As mentioned above, none of the above-described conventional technologies provides baked fatty or oily confectionery with crispy texture to the core without burnt taste.

### CITATION LIST

### Patent Document

Patent Document 1: JP No. 52-148662

Patent Document 2: JP A 10-210934

Patent Document 3: JP A 2000-189058

Patent Document 4: JP A 2002-223700

Patent Document 5: JP A 2001-314156

Patent Document 6: JP A 2002-119215

Patent Document 7: JP A 2002-119216

### DISCLOSURE OF INVENTION

### Problems to be Solved by the Invention

Therefore, an object of the present invention is to provide baked fatty or oily confectionery having a crispy texture to the core, without burnt taste.

### Means for Solving the Problems

As a result of intensive studies to accomplish the above object, the present inventors have found that the baked fatty or oily confectionery comprising a glucide selected from isomaltulose, mannitol, and reduced palatinose becomes baked confectionery having crispy texture to the core; and based on this, the present invention has been accomplished.

Namely, the present invention relates to the following baked confectionery and a manufacturing method thereof.

[1] A method of manufacturing baked fatty or oily confectionery, comprising preparing a fatty or oily confectionery composition containing a glucide selected from isomaltulose, mannitol and reduced palatinose, and baking the composition.
[2] The method according to [1], wherein the content of the glucide selected from isomaltulose, mannitol and reduced palatinose in the fatty or oily confectionery composition is 3-25 wt %.
[3] The method according to [1] or [2], wherein the fatty or oily confectionery composition comprises sucrose.
[4] The method according to [3], wherein the weight ratio of the glucide selected from isomaltulose, mannitol and reduced palatinose to the sucrose in the fatty or oily confectionery composition is 1:1-1:14.
[5] The method according to any one of [1] to [4], wherein the fatty or oily confectionery composition comprises cocoa powder.
[6] The method according to any one of [1] to [5], wherein the baking temperature is 160° C.-250° C.

[7] Baked fatty or oily confectionery made by baking a fatty or oily confectionery composition, wherein the fatty or oily confectionery composition comprises a glucide selected from isomaltulose, mannitol and reduced palatinose.

[8] Baked fatty or oily confectionery manufactured by the method according to any one of [1] to [6].

In further embodiments, the present invention relates to the following baked confectionery and its manufacturing method.

(1) A manufacturing method of baked confectionery, characterized in that a fatty or oily confectionery composition comprising isomaltulose is prepared and baked.
(2) The manufacturing method of baked confectionery according to (1), wherein the content of the isomaltulose is 3-25 wt %.
(3) The manufacturing method of baked confectionery according to (1) or (2), wherein cocoa powder is contained.
(4) The manufacturing method of baked confectionery according to any one of (1) to (3), wherein the baking temperature is 160° C.-250° C.
(5) Baked fatty or oily confectionery comprising isomaltulose.
(6) The baked fatty or oily confectionery according to (5), wherein the content of the isomaltulose is 3-25 wt %.
(7) The baked fatty or oily confectionery according to (5) or (6), comprising cocoa powder.

### Advantageous Effects of Invention

The baked confectionery of the present invention is a baked fatty or oily confectionery having a crispy texture to the core without burnt taste, and therefore it is heat resistant, and suitable as a product for summer season consumption that is often exposed to high temperature.

### DESCRIPTION OF EMBODIMENTS

(Definition)

In the present application, the fatty or oily confectionery is not limited to chocolate that meets the standards, but it means a wide variety of fatty or oily confectioneries including chocolate and quasi chocolate defined in the provisions of the Fair Competition Codes concerning labeling of chocolate, as well as fat cream that does not fall into the provisions.

In the present application, the baked fatty or oily confectionery is literally a fatty or oily confectionery that was baked in an oven, etc. The baking temperature is approximately 100° C. or higher as the internal air temperature of the oven, etc.

(Raw Materials)

In the baked confectionery of the present application, a glucide selected from isomaltulose, mannitol, and reduced palatinose is used as an essential ingredient.

In the baked confectionery of the present application, it is preferable that the content of the glucide selected from isomaltulose, mannitol, and reduced palatinose is 3-25 wt %, because texture of the baked confectionery becomes suitable for the object of the present invention.

Furthermore, in the baked confectionery of the present application, it is preferable that the content of the glucide selected from isomaltulose, mannitol, and reduced palatinose is 6-15 wt %, because texture of the baked confectionery becomes particularly suitable for the object of the present invention.

In the present application, raw materials other than the glucide selected from isomaltulose, mannitol, and reduced palatinose are the same as those for general fatty or oily confectionery; sugar (sucrose), whole milk powder, cocoa mass, cocoa butter, vegetable oil, lecithin, etc. can be used.

As other raw materials, other glucides, dairy products, fats and oils, salts such as common salt, pigments, emulsifiers, flavors, and other ingredients may also be appropriately used as necessary in a range that meets the object of the present application.

As examples of the other glucides, it is possible to use sugars such as starch, pregelatinized starch, lactose, glucose, fructose, trehalose, dextrin, and cellulose, sugar alcohols such as maltitol and sorbitol.

It is preferable that the fatty or oily confectionery composition further comprises sugar (sucrose); preferably, of all glucides in the fatty or oily confectionery composition, sucrose accounts for 15-95% wt %, preferably 30-90 wt %, more preferably 40-80 wt %, because texture of the baked confectionery becomes particularly suitable for the object of the present invention.

In the present specification, “total glucide” also includes other glucides, e.g., lactose derived from dairy products and polysaccharides such as starch, in addition to sugar (sucrose) and a glucide selected from isomaltulose, mannitol, and reduced palatinose.

In the fatty or oily confectionery composition, it is preferable that the weight ratio of the glucide selected from isomaltulose, mannitol, and reduced palatinose to sugar (sucrose) is 1:0.5-1:15, preferably 1:1-1:14, and more preferably 1:2-1:7, because texture of the baked confectionery becomes particularly suitable for the object of the present invention.

It is desirable that the fatty or oily confectionery composition comprises cocoa powder; the content of the cocoa powder in the fatty or oily confectionery composition is 1-10 wt %, preferably 2-5 wt %, because taste of the baked confectionery becomes particularly suitable for the object of the present invention.

Preferably, the cocoa content (total amount of cocoa nibs, cocoa mass, cocoa, butter, cocoa cake and cocoa powder excluding moisture) in the fatty or oily confectionery composition is 7 wt % or more, preferably 15 wt % or more, and furthermore preferably 21 wt % or more, because taste of the baked confectionery becomes particularly suitable for the object of the present invention.

Examples of dairy product include skimmed milk powder, cream powder, and dry whey, etc.

Examples of fats and oils include tempering fats and non-tempering fats derived from animals, plants or both, or their mixture of substitute fats and oils, including sal fat butter, shea fat, palm oil, milk fat, DHA, EPA, shortening, and margarine, etc.

Examples of emulsifier include sucrose fatty acid esters, polyglycerol fatty acid esters, etc.

Examples of flavor include vanillin and vanilla extract, etc.

(Manufacturing Method)

The baked confectionery of the present application can be manufactured, for example, as follows.

First, a fatty or oily confectionery composition of the present application can be obtained as follows: a glucide selected from isomaltulose, mannitol and reduced palatinose, and powder materials such as sugar, lactose, whole milk powder, skimmed milk powder, cream powder, etc., and oily liquid materials such as melted cocoa mass, cocoa, butter, vegetable oil, lecithin, etc, are mixed by stirring such that the oily content of the mixture becomes suitable for refining (generally 25-30%), thereby obtaining a paste-type seed composition; then the seed composition is refined and the obtained flakes are subjected to conching, and liquidized into a paste-like condition; then, further oily materials such as cocoa butter and vegetable oil, etc., as well as lecithin are added and mixed by stirring to achieve the desired oily content and viscosity. Furthermore, flavors, etc. may be added as necessary.

Next, thus-obtained fatty or oily confectionery composition is baked in an oven, etc. Baking is carried out at an internal air temperature of the oven of 160-250° C., more preferably 160-200° C., taking into account flavors after completion of the baking. In order to bake the composition such that crispy texture is achieved to the core without generating burnt taste, it is necessary to appropriately adjust the baking time in accordance with baking temperature. In addition, it is preferable that the thickness of the baked confectionery after baking is adjusted to 10 mm or less, preferably less than 10 mm, more preferably 1-8 mm, and furthermore preferably 2-5 mm, because texture of the baked confectionery becomes particularly suitable for the object of the present invention. Thus, the baked confectionery of the present application can be obtained.

### EXAMPLES

Hereinafter, the present invention is explained in detail with reference to examples; however, the present invention is not limited thereto.

Test Example 1

A fatty or oily confectionery composition was prepared by homogeneously mixing 90 parts by weight of a basic composition with the formulation listed in Table 1 and 10 parts by weight of an added substance shown in Table 2, and the composition was formed into 28-mm height, 28-mm width and 3-mm thickness, baked in an oven at 200° C., and the hardness and texture of the baked confectionery obtained were evaluated. Table 3 shows the results.

Samples to which isomaltulose, mannitol or reduced palatinose was added exhibited preferable crispy texture.

Samples to which sugar (sucrose) was added did not exhibit crispy texture by baking for a short period of time; whereas they exhibited crispy texture by baking for a long period of time, but with burnt taste.

The whole milk powder used here comprises approximately 36 wt % of lactose.

Measurement Condition of Hardness

Samples: The baked confectionery obtained as described above is subjected to aging for 20 hr under the environmental conditions of 20° C. and relative humidity of 25%.

The number of samples and calculation method: Measurement is performed at 5 points in each experimental section, and an average value is calculated.

Rheometer: RTC-301 OD-CW from Fudoh

Plunger: Cylindrical shape with 3-mm diameter

Approach speed: 4 cm/min

Penetration depth: 3 mm

TABLE 1

| Raw material | Formulation (wt %) |
|---|---|
| Cocoa mass | 6 |
| Whole milk powder | 26 |
| (containing approx. | |
| 36 wt % of lactose) | |
| Sugar | 44.4 |
| Cocoa butter | 23 |
| Lecithin | 0.6 |

TABLE 2

| | | Method of addition, |
|---|---|---|
| | Added substance | Baking condition |
| Ex. 1 | Isomaltulose | Homogeneously mixed into basic |
| | hydrate | composition, 7-min baking |
| Ex. 2 | Mannitol | Homogeneously mixed into basic |
| | | composition, 7-min baking |
| Ex. 3 | Reduced | Homogeneously mixed into basic |
| | palatinose | composition, 7-min baking |
| Control | None | Basic composition alone, |
| | | 7-min baking |
| Comp. | Sucrose | Homogeneously mixed into basic |
| ex. 1 | (powdered sugar) | composition, 7-min baking |
| Comp. | Sucrose | Homogeneously mixed into basic |
| ex. 2 | (powdered sugar) | composition, 15-min baking |

TABLE 3

| | Hardness (gf) | Texture |
|---|---|---|
| Ex. 1 | 1330 | Sufficient crispy texture |
| Ex. 2 | 2237 | Sufficient crispy texture |
| Ex. 3 | 2717 | Sufficient crispy texture |
| Control | 1170 | Crunchy light texture |
| Comp. | 1713 | Moist |
| ex. 1 | | |
| Comp. | 1667 | Sufficient crispy texture, |
| ex. 2 | | with burnt taste |

Test Example 2

A fatty or oily confectionery composition was prepared using the basic composition of Table 1 and in accordance with the formulation of Table 4, baked in an oven at 200° C. for 7 min, and the hardness and texture of the baked confectionery obtained were evaluated similarly to Test example 1.

Table 5 shows the results. Particularly preferred texture was obtained in Examples 6, 7 and 8.

TABLE 4

| Raw material | Ex. 4 | Ex. 5 | Ex. 6 | Ex. 7 | Ex. 8 | Ex. 9 |
|---|---|---|---|---|---|---|
| Basic | 90 | 86.951 | 90 | 79.979 | 73.002 | 59.457 |
| composition | | | | | | |
| Whole | 0.518 | 0 | 0 | 0 | 0 | 0 |
| milk powder | | | | | | |
| Sugar | 0 | 1.364 | 0 | 1.254 | 1.145 | 0.933 |
| Cocoa butter | 2.255 | 3.182 | 0 | 5.564 | 7.929 | 12.523 |
| Isomaltulose | 3 | 4.545 | 6 | 9.594 | 14.601 | 24.38 |
| Cocoa butter, | 4.227 | 3.958 | 4 | 3.639 | 3.323 | 2.707 |
| 12 wt % oily | | | | | | |
| content | | | | | | |

TABLE 5

| | Hardness (gf) | Texture |
|---|---|---|
| Ex. 4 | 1517 | Crispy texture |
| Ex. 5 | 1080 | Crispy texture |
| Ex. 6 | 1148 | Sufficient crispy texture |
| Ex. 7 | 1360 | Sufficient crispy texture |
| Ex. 8 | 1980 | Sufficient crispy texture |
| Ex. 9 | 1450 | Sufficient crispy texture with oozing of |
| | | slight oil |

1-8. (canceled)

9. A method of manufacturing baked confectionery selected from baked chocolate, baked quasi chocolate, and baked fat cream, comprising adding a glucide selected from isomaltulose, mannitol and reduced palatinose into a fatty or oily confectionery composition selected from chocolate, quasi chocolate, and fat cream, and baking the composition.

10. The method according to claim 1, wherein the content of the glucide selected from isomaltulose, mannitol and reduced palatinose in the fatty or oily confectionery composition is 3-25 wt %.

11. The method according to claim 1, wherein the fatty or oily confectionery composition comprises sucrose.

12. The method according to claim 3, wherein the weight ratio of the glucide selected from isomaltulose, mannitol and reduced palatinose to the sucrose in the fatty or oily confectionery composition is 1:1 to 1:14.

13. The method according to claim 1, wherein the fatty or oily confectionery composition comprises cocoa powder.

14. The method according to claim 1, wherein the baking temperature is from 160° C. to 250° C.

15. Baked fatty or oily confectionery made by baking a fatty or oily confectionery composition selected from chocolate, quasi chocolate, and fat cream, wherein the fatty or oily confectionery composition comprises a glucide selected from isomaltulose, mannitol and reduced palatinose.

16. Baked fatty or oily confectionery manufactured by the method according to claim 1.
